(19) United States
(12) Patent Application Publication
(10) Pub. No.: US 2022/0172045 A1
(43) Pub. Date: Jun. 2, 2022

(54) CONVOLUTIONAL NEURAL NETWORK DETERMINATION FOUNDATION EXTRACTION METHOD AND DEVICE

(71) Applicant: HAMAMATSU PHOTONICS K.K., Hamamatsu-shi, Shizuoka (JP)

(72) Inventors: Masashi FUKUHARA, Hamamatsu-shi, Shizuoka (JP); Kazuhiko FUJIWARA, Hamamatsu-shi, Shizuoka (JP); Yoshihiro MARUYAMA, Hamamatsu-shi, Shizuoka (JP)

(73) Assignee: HAMAMATSU PHOTONICS K.K., Hamamatsu-shi, Shizuoka (JP)

(21) Appl. No.: 17/437,871

(22) PCT Filed: Feb. 25, 2020
(86) PCT No.: PCT/JP2020/007497

§ 371 Date: Sep. 10, 2021

(30) Foreign Application Priority Data
Mar. 15, 2019 (JP) 2019-048512

(51) Int. Cl. G06N 3/08; G06N 3/063; G06K 9/62

(52) U.S. Cl. CPC G06N 3/08; G06K 9/6256; G06N 3/063

(57) ABSTRACT

A convolutional neural network decision basis extraction apparatus includes a contribution rate calculation unit and a basis extraction unit. The contribution rate calculation unit obtains a contribution rate of a weight of a fully connected layer to an output label of an output layer. The basis extraction unit extracts a decision basis of a CNN based on a feature map input to the fully connected layer, the weight of the fully connected layer, and the above contribution rate.

### TECHNICAL FIELD

The present disclosure relates to a method and an apparatus for extracting a decision basis of a convolutional neural network.

### BACKGROUND ART

In general, classification using a deep neural network (DNN) can achieve a high correct answer rate. However, on the other hand, it is difficult for human beings to determine a calculation process in the classification by the DNN. Therefore, for a learning model by the DNN in general, there is a demand for visualizing a calculation process or decision criteria of the learning model so that human beings can understand to evaluate validity of the learning model.

A convolutional neural network (CNN), which is a type of the DNN, is used in a field of image recognition and the like, and application examples are recently reported also in a field of spectrum analysis (see Patent Document 1 and Non Patent Documents 1 and 2). In the field of spectrum analysis, a principal component analysis for extracting a feature, a classifier such as a support vector machine, and the like are used and achieve significant results for many years. In recent years, the CNN is used also in the field of spectrum analysis, and the results are reported.

In the field of image recognition by the CNN, a technique is known in which a discriminative region serving as a classification basis by the CNN in an input image is displayed on the input image (see Non Patent Document 3). With this technique, it is possible to evaluate the validity of the learning model by the CNN. However, in the field of spectrum analysis by the CNN, there is no known technique for obtaining a discriminative region serving as a classification basis by the CNN in an input spectrum.

### CITATION LIST

### Patent Literature

Patent Document 1: Japanese Patent Publication No. 6438549

### Non Patent Literature

Non Patent Document 1: J. Liu et al., “Deep convolutional neural networks for Raman spectrum recognition: a unified solution”, Analyst, 142, 21, pp.4067-4074 (2017)

Non Patent Document 2: J. Acquarelli et al., “Convolutional neural networks for vibrational spectroscopic data analysis”, Anal. Chim. Acta, 954, pp.22-31 (2017)

Non Patent Document 3: R. R. Selvaraju et al., “Grad-CAM: Visual Explanations from Deep Networks via Gradient-based Localization”, arXiv:1610.02391v3 (2017)

### SUMMARY OF INVENTION

### Technical Problem

According to studies by the present inventors, when the technique described in Non Patent Document 3 is applied to the spectrum analysis by the CNN, it is difficult to obtain a discriminative region serving as a classification basis by the CNN. The reason is considered as follows.

When the image recognition is performed by the CNN, the CNN needs to have a deep network structure with the hidden layers of sixteen or more layers. The technique described in Non Patent Document 3 performs a calculation based on a feature map obtained by a calculation in a convolutional layer or a pooling layer of the CNN to display, on an input image, a discriminative region serving as a classification basis in the input image.

On the other hand, when the spectrum analysis is performed by the CNN, in the CNN, a network structure having relatively few hidden layers (several layers) is considered to be sufficient. In such a network structure, in the calculation based on the feature map obtained by the calculation in the convolutional layer or the pooling layer as described in Non Patent Document 3, it is considered difficult to obtain a discriminative region serving as a classification basis by the CNN in an input spectrum. Further, since a size of a filter used in the convolutional layer is about a line width of the spectrum, the calculation based on the feature map can only acquire shape information rather than position information.

The above problem is considered to exist not only when the CNN is applied to the field of spectrum analysis, but also when the number of hidden layers in the CNN is small or when the size of the filter used in the convolutional layer in the CNN is small.

An object of the present invention is to provide a method and an apparatus capable of extracting a discriminative region serving as a decision basis by a CNN in input data, even when the number of hidden layers of the CNN is small or a size of a filter used in a convolutional layer is small.

### Solution to Problem

An embodiment of the present invention is a convolutional neural network decision basis extraction method. The decision basis extraction method is a method for extracting a decision basis of a convolutional neural network having an input layer, a convolutional layer, a pooling layer, a fully connected layer, and an output layer, and includes a contribution rate calculation step of obtaining a contribution rate of a weight of the fully connected layer to an output label of the output layer; and a basis extraction step of extracting the basis based on a feature map input to the fully connected layer, the weight of the fully connected layer, and the contribution rate.

An embodiment of the present invention is a convolutional neural network decision basis extraction method. The decision basis extraction method is a method for extracting a decision basis of a convolutional neural network having an input layer, a convolutional layer, a pooling layer, a fully connected layer, and an output layer, and includes a contribution rate calculation step of obtaining a contribution rate of a feature vector generated by the fully connected layer to an output label of the output layer; and a basis extraction step of extracting the basis based on a feature map input to the fully connected layer, a weight of the fully connected layer, and the contribution rate. The feature vector is generated based on the feature map input to the fully connected layer and the weight of the fully connected layer.

An embodiment of the present invention is a convolutional neural network decision basis extraction apparatus. The decision basis extraction apparatus is an apparatus for extracting a decision basis of a convolutional neural network having an input layer, a convolutional layer, a pooling layer, a fully connected layer, and an output layer, and includes a contribution rate calculation unit for obtaining a contribution rate of a weight of the fully connected layer to an output label of the output layer; and a basis extraction unit for extracting the basis based on a feature map input to the fully connected layer, the weight of the fully connected layer, and the contribution rate.

An embodiment of the present invention is a convolutional neural network decision basis extraction apparatus. The decision basis extraction apparatus is an apparatus for extracting a decision basis of a convolutional neural network having an input layer, a convolutional layer, a pooling layer, a fully connected layer, and an output layer, and includes a contribution rate calculation unit for obtaining a contribution rate of a feature vector generated by the fully connected layer to an output label of the output layer; and a basis extraction unit for extracting the basis based on a feature map input to the fully connected layer, a weight of the fully connected layer, and the contribution rate.

### Advantageous Effects of Invention

According to the embodiments of the present invention, it is possible to extract a discriminative region serving as a decision basis by a CNN in input data, even when the number of hidden layers of the CNN is small or a size of a filter used in a convolutional layer is small.

### BRIEF DESCRIPTION OF DRAWINGS

FIG. 1 is a diagram illustrating a configuration example of a convolutional neural network.

FIG. 2 is a diagram illustrating a configuration of a convolutional neural network decision basis extraction apparatus.

FIG. 3 is a diagram illustrating another configuration example of the convolutional neural network.

FIG. 4 is a diagram showing a discriminative region serving as a classification basis obtained in a first example.

FIG. 5 is a diagram showing a discriminative region serving as a classification basis obtained in the first example.

FIG. 6 is a diagram showing a discriminative region serving as a classification basis obtained in the first example.

FIG. 7 includes (a) a diagram showing a discriminative region serving as a classification basis obtained in a second example, and (b) a diagram showing an enlarged part of (a).

FIG. 8 includes (a) a diagram showing a discriminative region serving as a classification basis obtained in the second example, and (b) a diagram showing an enlarged part of (a).

FIG. 9 is a diagram showing an example of a spectrum of each of nine types of drugs used in a third example.

FIG. 10 is a diagram showing a discriminative region serving as a classification basis obtained in the third example (drug A).

FIG. 11 is a diagram showing a discriminative region serving as a classification basis obtained in the third example (drug B).

FIG. 12 is a diagram showing a discriminative region serving as a classification basis obtained in the third example (drug C).

FIG. 13 is a diagram showing a discriminative region serving as a classification basis obtained in the third example (drug D).

FIG. 14 is a diagram showing a discriminative region serving as a classification basis obtained in the third example (drug E).

FIG. 15 is a diagram showing a discriminative region serving as a classification basis obtained in the third example (drug F).

FIG. 16 is a diagram showing a discriminative region serving as a classification basis obtained in the third example (drug G).

FIG. 17 is a diagram showing a discriminative region serving as a classification basis obtained in the third example (drug H).

FIG. 18 is a diagram showing a discriminative region serving as a classification basis obtained in the third example (drug I).

FIG. 19 is a diagram showing an example of a spectrum of each of twenty types of amino acids used in a fourth example.

FIG. 20 is a diagram showing a pure spectrum of alanine (Ala) used in the fourth example.

FIG. 21 is a diagram showing a discriminative region serving as a classification basis obtained in the fourth example.

FIG. 22 is a diagram showing a discriminative region serving as a classification basis obtained in the fourth example.

FIG. 23 is a diagram illustrating a configuration of a convolutional neural network decision basis extraction apparatus.

FIG. 24 is a diagram showing a discriminative region serving as a classification basis obtained in the third example.

FIG. 25 is a diagram showing a discriminative region serving as a classification basis obtained in a fifth example.

FIG. 26 is a diagram showing a discriminative region serving as a classification basis obtained in the fourth example.

FIG. 27 is a diagram showing a discriminative region serving as a classification basis obtained in a sixth example.

### DESCRIPTION OF EMBODIMENTS

Hereinafter, embodiments of a convolutional neural network decision basis extraction method and an apparatus will be described in detail with reference to the accompanying drawings. In the description of the drawings, the same elements will be denoted by the same reference signs, and redundant description will be omitted. The present invention is not limited to these examples.

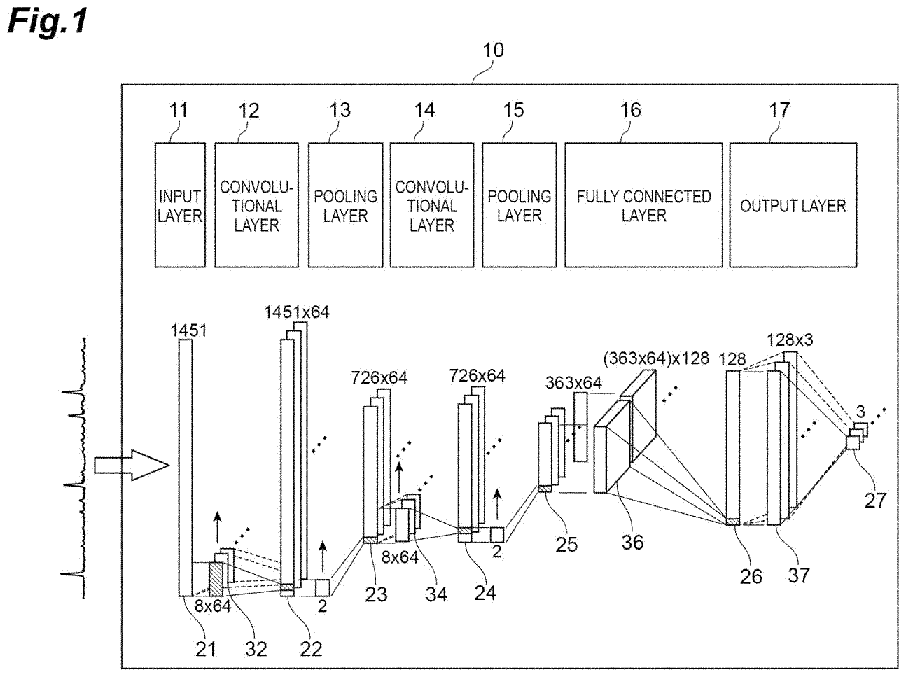

FIG. 1 is a diagram illustrating a configuration example of a convolutional neural network. The convolutional neural network (CNN) 10 of the configuration example illustrated in this diagram includes an input layer 11, a convolutional layer 12, a pooling layer 13, a convolutional layer 14, a pooling layer 15, a fully connected layer 16, and an output layer 17. The CNN 10 can be realized by a central processing unit (CPU), and can also be realized by a digital signal processor (DSP) or a graphics processing unit (GPU) capable of higher-speed processing. Further, the CNN 10 also includes a memory that stores various types of data and parameters.

The convolutional layer 12 applies a filter 32 to an input data string 21 input to the input layer 11 to generate a feature map 22. The convolutional layer 12 generates the feature map 22 by moving the filter 32 relatively with respect to the input data string 21, and performing a convolution operation of the input data string 21 and the filter 32 at each position. In general, the convolutional layer 12 uses a plurality of filters 32, and generates the same number of feature maps 22 as the filters 32.

The pooling layer 13 reduces the feature map 22 generated by the convolutional layer 12 to generate a feature map 23. For example, the pooling layer 13 extracts two pieces of data from the feature map 22, and calculates a maximum value or an average value of the two pieces of data to generate the feature map 23 having a size of half of the feature map 22.

The convolutional layer 14 applies a filter 34 to the feature map 23 generated by the pooling layer 13 to generate a feature map 24. The convolutional layer 14 generates the feature map 24 by moving the filter 34 relatively with respect to the feature map 23, and performing a convolution operation of the feature map 23 and the filter 34 at each position.

The pooling layer 15 reduces the feature map 24 generated by the convolutional layer 14 to generate a feature map 25. For example, the pooling layer 15 extracts two pieces of data from the feature map 24, and calculates a maximum value or an average value of the two pieces of data to generate the feature map 25 having a size of half of the feature map 24.

The fully connected layer 16 applies a weight 36 to the feature map 25 generated by the pooling layer 15 to generate a feature vector 26. The output layer 17 applies a weight 37 to the feature vector 26 generated by the fully connected layer 16 to generate an output label 27.

It is assumed that a size of the feature map 25 is I, the number of the feature maps is K, and a value of a position i of the k-th feature map is A_{i,k}. It is assumed that a size of the weight 36 of the fully connected layer is I×K, the number of the weights of the fully connected layer is M, and a value of a position (i, k) in the m-th weight of the fully connected layer is Fw_{i,k,m}. A size of the feature vector 26 is M. It is assumed that a size of the weight 37 of the output layer is M, the number of the weights of the output layer is C, and a value of a position in in the c-th weight of the output layer is G_{c,m}. A value y_{c} of a label c in the output labels 27 is represented by the following Formula (1).

$$\begin{matrix}[ Formula 1 ] & \\ {y}_{c} = {\sum }_{i} {\sum }_{k} {\sum }_{m} {A}_{i , k} \cdot {Fw}_{i , k , m} \cdot {G}_{c , m} & ( 1 )\end{matrix}$$

The CNN 10 is trained based on a comparison between the output labels 27 of the output layer when training data is input to the input layer 11 of the CNN 10 and training labels corresponding to the training data. By performing the learning using a large number of the training data and the training labels, the filter 32, the filter 34, the weight 36 of the fully connected layer, and the weight 37 of the output layer are optimized.

When evaluation data is input to the input layer 11 of the trained CNN 10, the evaluation data is classified by the CNN 10, and the classification result appears in the output label 27 of the output layer. A convolutional neural network decision basis extraction apparatus 1 and a method of the present embodiment extract a discriminative region serving as a decision basis by the CNN 10 in the input evaluation data.

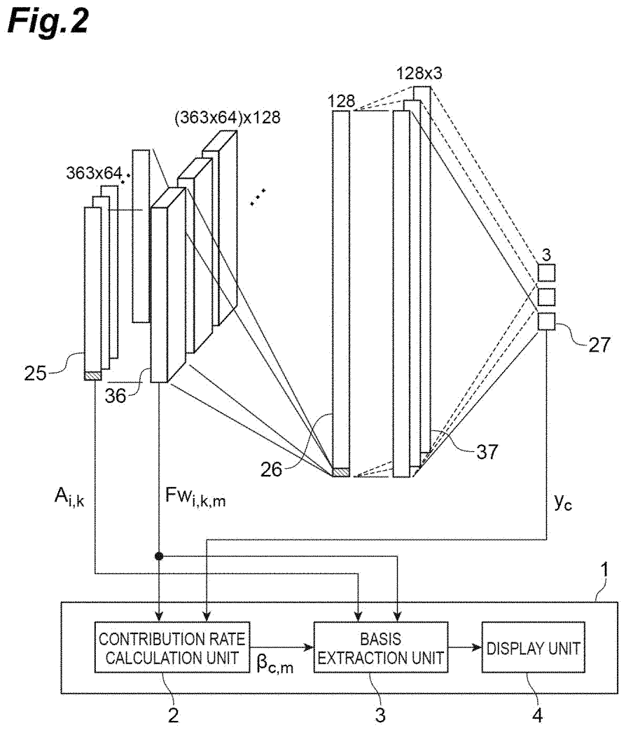

FIG. 2 is a diagram illustrating a configuration of the convolutional neural network decision basis extraction apparatus 1. In this diagram, in addition to the convolutional neural network decision basis extraction apparatus (CNN decision basis extraction apparatus) 1, the feature map 25, the feature vector 26, the output label 27 of the output layer, the weight 36 of the fully connected layer, and the weight 37 of the output layer in the CNN 10 are also illustrated.

The CNN decision basis extraction apparatus 1 can be realized by a computer including a CPU, a memory, and the like, and includes a display unit such as a liquid crystal display that displays input data, output data, and the like. The CNN decision basis extraction apparatus 1 may be realized by a computer together with the CNN 10.

The CNN decision basis extraction apparatus 1 includes a contribution rate calculation unit 2 and a basis extraction unit 3, and preferably further includes a display unit 4.

The contribution rate calculation unit 2 obtains a contribution rate of the weight 36 of the fully connected layer to any output label of the output layer 17. The contribution rate β_{c,m} of the m-th weight 36 of the fully connected layer to the value y_{c} of the label c in the output labels 27 is represented by the following Formula (2), as a ratio of the change amount of y_{c} to the change amount of Fw_{i,k,m}.

$$\begin{matrix}[ Formula 2 ] & \\ {β}_{c , m} = {\sum }_{i} {\sum }_{k} \frac{\partial {y}_{c}}{\partial F {w}_{i , k , m}} & ( 2 )\end{matrix}$$

The basis extraction unit 3 extracts the basis of the decision in the CNN 10 based on the feature map 25 input to the fully connected layer 16, the weight 36 of the fully connected layer, and the above contribution rate β_{c,m}. An i-th value Q_{c,i} of a data string Q_{c} showing the decision basis of the CNN 10 is represented by the following Formula (3), as a value obtained by summing the products of A_{i,k}, β_{c,m} and Fw_{i,k,m} for k and m. A size of the data string Q_{c} is I.

$$\begin{matrix}[ Formula 3 ] & \\ {Q}_{c , i} = {\sum }_{k} {A}_{i , k} ( {\sum }_{m} {β}_{c , m} \cdot {Fw}_{i , k , m} ) & ( 3 )\end{matrix}$$

The display unit 4 displays the data string Q_{c} representing the decision basis of the CNN 10 in association with the input data input to the input layer 11.

The convolutional neural network decision basis extraction method (CNN decision basis extraction method) includes a contribution rate calculation step and a basis extraction step, and preferably further includes a display step. In the contribution rate calculation step, the contribution rate β_{c,m} of the weight 36 of the fully connected layer to the output label of the output layer 17 is obtained (Formula (2)). In the basis extraction step, the decision basis of the CNN 10 is extracted based on the feature map 25 input to the fully connected layer 16, the weight 36 of the fully connected layer, and the contribution rate β_{c,m} (Formula (3)). In the display step, the data string Q_{c} representing the decision basis of the CNN 10 is displayed in association with the input data input to the input layer 11.

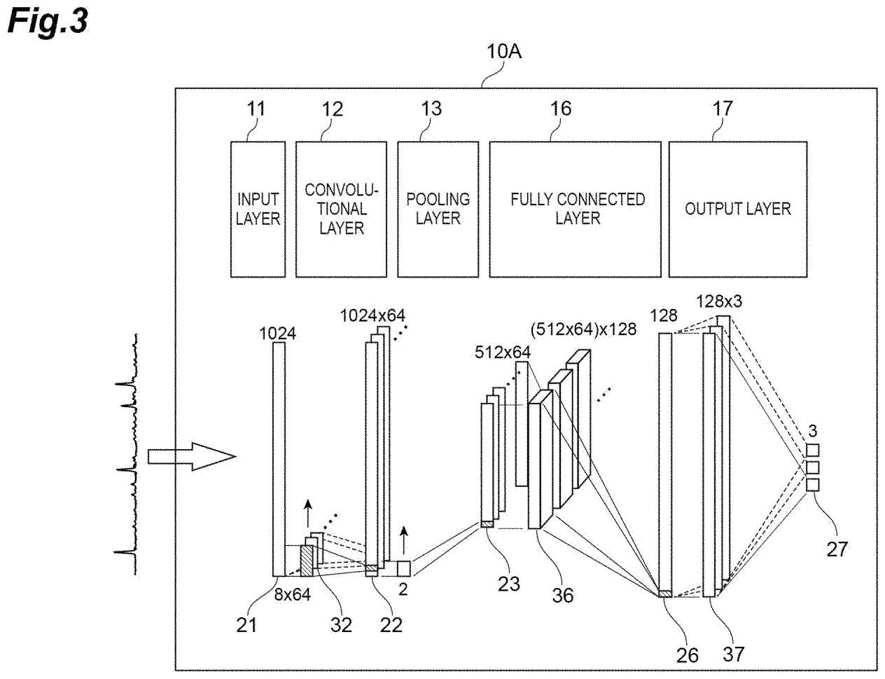

FIG. 3 is a diagram illustrating another configuration example of the convolutional neural network. The convolutional neural network (CNN) 10A of the configuration example illustrated in this diagram includes the input layer 11, the convolutional layer 12, the pooling layer 13, the fully connected layer 16, and the output layer 17. The CNN 10 illustrated in FIG. 1 includes two sets of the convolutional layers and the pooling layers, whereas the CNN 10A illustrated in FIG. 3 includes one set of the convolutional layer and the pooling layer. The CNN decision basis extraction apparatus 1 illustrated in FIG. 2 is also applicable to the CNN of the configuration illustrated in FIG. 3.

Next, first to fourth examples will be described. In the first and second examples, the CNN having the configuration illustrated in FIG. 3 was used. In the third and fourth examples, the CNN having the configuration illustrated in FIG. 1 was used.

The first example is as follows. In the first example, simulated spectra having simple shapes were used as training data and evaluation data. In each of the training spectrum and the evaluation spectrum, the number of channels was set to 1024, and a maximum peak was provided at any position of 100 ch, 500 ch, and 1000 ch. Further, in each of the training spectrum and the evaluation spectrum, noise peaks were provided at three positions different from 100 ch, 500 ch, and 1000 ch, and white noise was further provided.

Each of the maximum peak and the noise peaks was set to a Lorentz function shape, the maximum peak value was normalized as 1, and the noise peak value was set to a random value in a range of 0.1 or more and less than 1. The training labels corresponding to the training spectrum were given as the maximum peak position (any of 100 ch, 500 ch, and 1000 ch) of the training spectrum, by a one-hot vector (array in which the correct training label is 1, and the other labels are 0).

In the first example, the CNN of the configuration illustrated in FIG. 3 was used. The size of the filter 32 was 8, and the number thereof was 64. The size of the weight 36 of the fully connected layer was 512×64, and the number thereof was 128. The size of the weight 37 of the output layer was 128, and the number thereof was 3. The training spectrum and the training labels were used to train the CNN.

The evaluation spectrum was input to the trained CNN, and classification of the evaluation spectrum was performed by the CNN. A discriminative region being a classification basis was obtained from the fully connected layer by the present embodiment (example) and obtained from the pooling layer by the technique described in Non Patent Document 3 (comparative example).

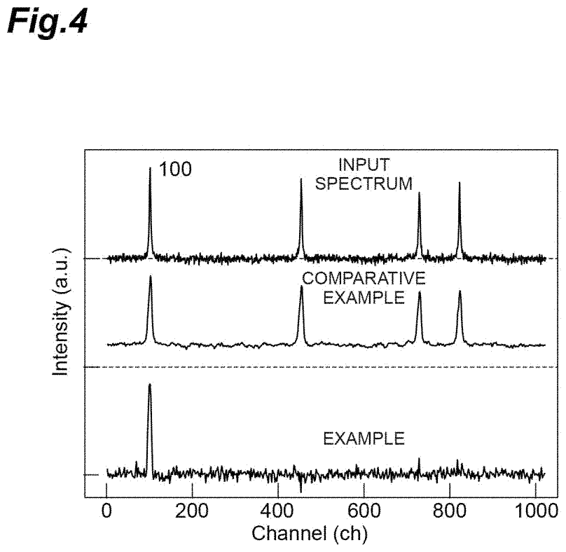

Each of FIG. 4 to FIG. 6 is a diagram showing a discriminative region serving as a classification basis obtained in the first example. Each of the diagrams shows, in order from the top, an input evaluation spectrum, a data string showing the discriminative region serving as the classification basis obtained by the comparative example, and a data string Q_{c} (Formula (3)) showing the discriminative region serving as the classification basis obtained by the example.

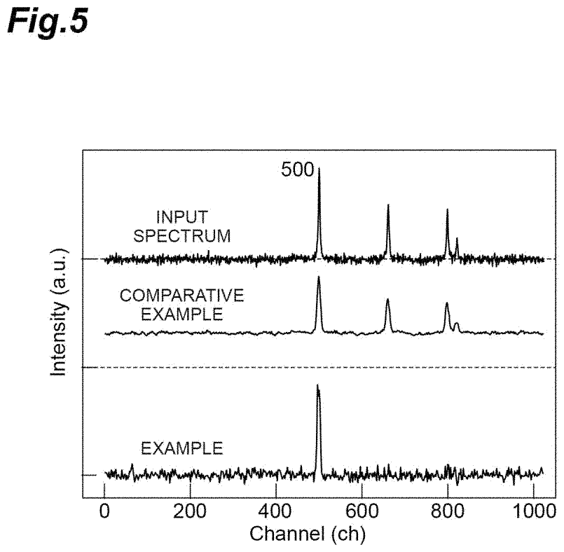

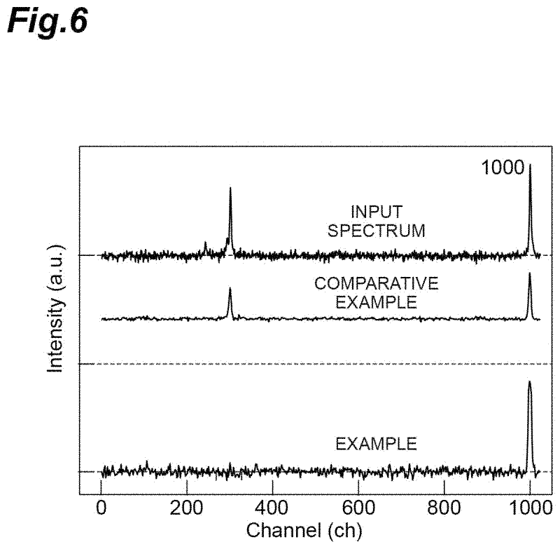

FIG. 4 shows an example in which the maximum peak position of the evaluation spectrum is 100 ch. FIG. 5 shows an example in which the maximum peak position of the evaluation spectrum is 500 ch. FIG. 6 shows an example in which the maximum peak position of the evaluation spectrum is 1000 ch.

In each of FIG. 4 to FIG. 6, in the comparative example, the discriminative region serving as the classification basis exists not only at the maximum peak position but also at the noise peak positions. On the other hand, in the example, the discriminative region serving as the classification basis exists only at the maximum peak position. As compared with the comparative example, in the example, the discriminative region serving as the classification basis is more accurately shown.

The second example is as follows. In the second example, as the training data and the evaluation data, the training spectrum and the evaluation spectrum same as those used in the first example were used. In addition, a noise peak of a Lorentz function shape was not included in the evaluation spectrum.

In the second example, the configuration same as that of the CNN used in the first example was used. In addition, the size and the number of the filter 32 were set to various values, the CNN was caused to perform the learning and the classification, and the data string Q_{c} (Formula (3)) showing the discriminative region serving as the classification basis was obtained.

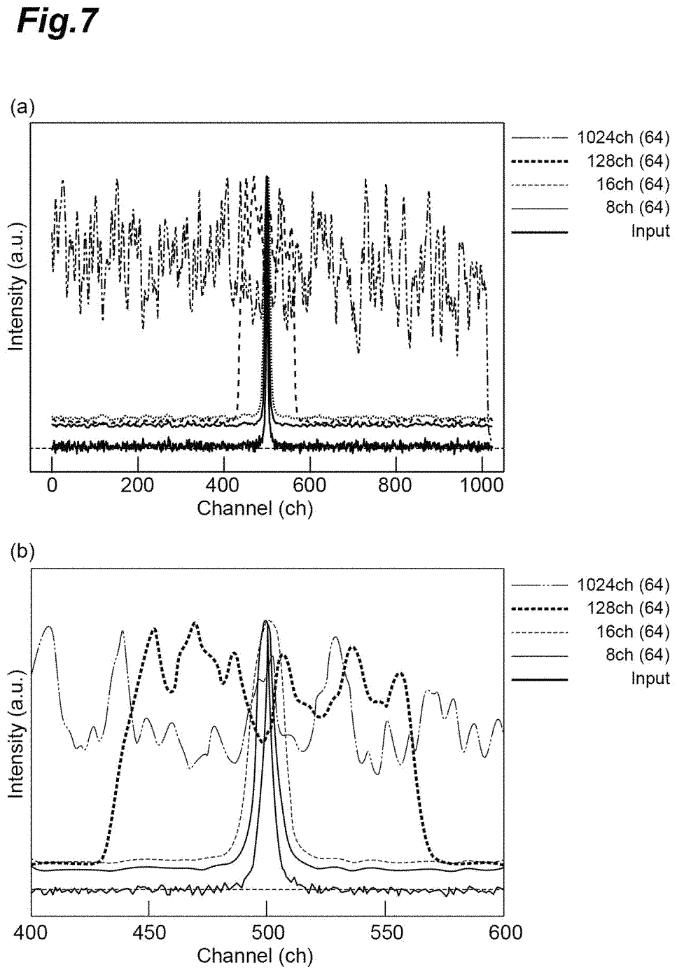

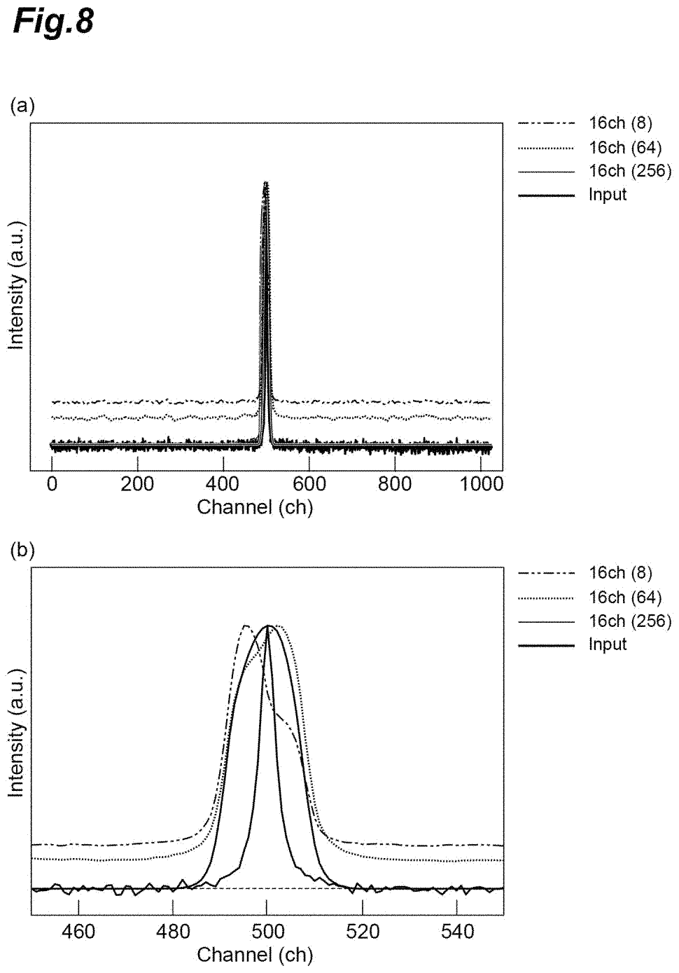

Each of FIG. 7 and FIG. 8 is a diagram showing a discriminative region serving as a classification basis obtained in the second example. Each of the diagrams shows an input evaluation spectrum, and a data string Q_{c} (Formula (3)) showing the discriminative region serving as the classification basis obtained by the example.

(a) and (b) in FIG. 7 shows an example in which the number of the filters is fixed to 64, and the size of the filter is set to any value of 8, 16, 128, and 1024. (b) in FIG. 7 shows an enlarged part of (a) in FIG. 7. From this diagram, it can be seen that the CNN focuses on the vicinity of the maximum peak position of the input evaluation spectrum as the classification basis as the size of the filter is closer to the spectrum width.

(a) and (b) in FIG. 8 shows an example in which the size of the filter is fixed to 16, and the number of the filters is set to any value of 8, 64, and 256. (b) in FIG. 8 shows an enlarged part of (a) in FIG. 8. From this diagram, it can be seen that the CNN regards the position closer to the maximum peak position of the input evaluation spectrum as the classification basis as the number of the filters increases.

The above example shows that it is possible to optimize the size and the number of the filters.

The third example is as follows. In the third example, Raman spectra of nine types of commercially available drugs A to I were used as the training spectra and the evaluation spectra. A Raman spectrum measured for each drug was subjected to interpolation processing to generate a spectrum in a wavenumber range of 350 cm⁻¹ to 1800 cm⁻¹ at intervals of 1 cm⁻¹.

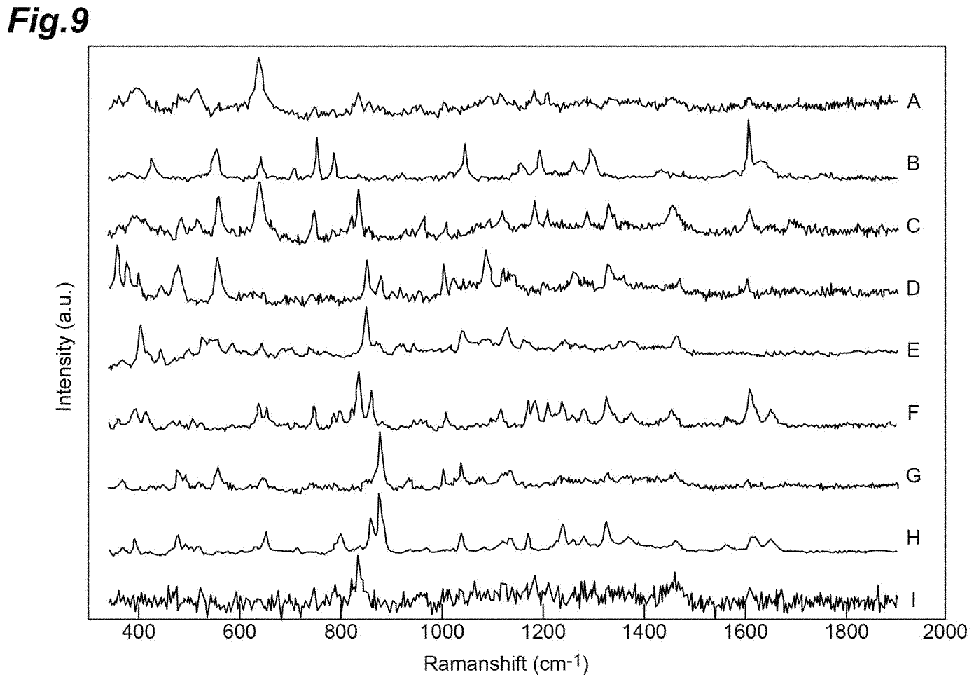

In each of the training spectrum and the evaluation spectrum, the number of channels was set to 1451, and the maximum peak value was normalized as 1. Further, for each of the nine types of drugs, four spectra having different SN ratios were used as the training spectra. FIG. 9 is a diagram showing examples of spectra for the nine types of drugs used in the third example.

In the third example, the CNN of the configuration illustrated in FIG. 1 was used. The size of the filter 32 was 8, and the number thereof was 64. The size of the filter 34 was 8, and the number thereof was 64. The size of the weight 36 of the fully connected layer was 363×64, and the number thereof was 128. The size of the weight 37 of the output layer was 128, and the number thereof was 3. The training spectrum and the training labels were used to train the CNN.

A spectrum different from the training spectrum was input to the CNN as an evaluation spectrum, and the classification of the evaluation spectrum was performed by the CNN. A discriminative region being a classification basis was obtained from the fully connected layer.

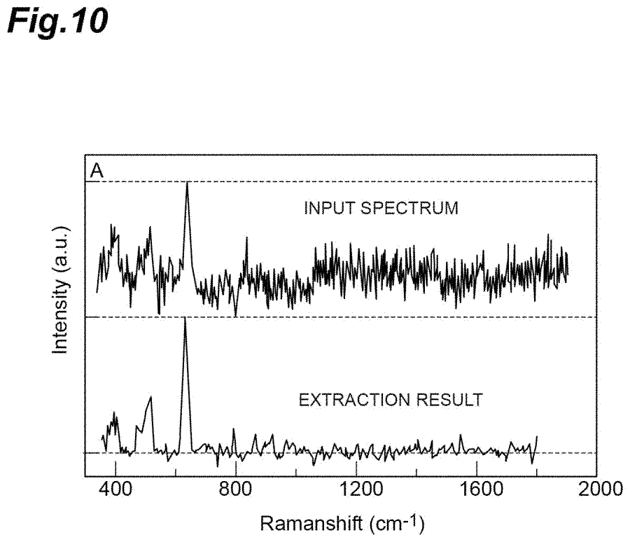

Each of FIG. 10 to FIG. 18 is a diagram showing a discriminative region serving as a classification basis obtained in the third example. Each of the diagrams shows an input evaluation spectrum, and a data string Q_{c} (Formula (3)) showing the discriminative region serving as the classification basis obtained by the example.

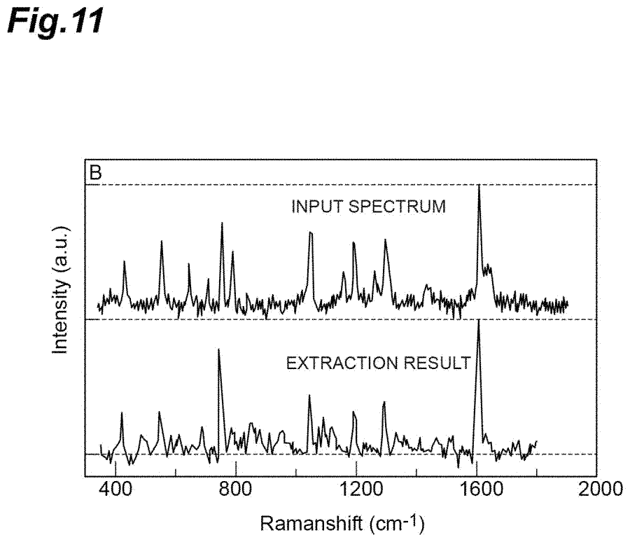

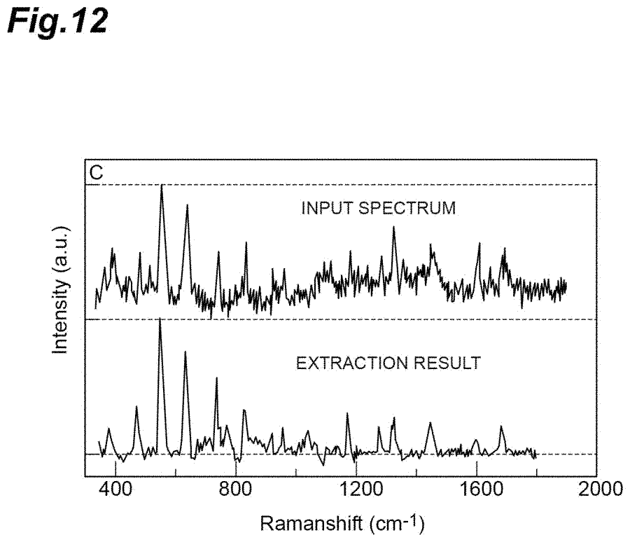

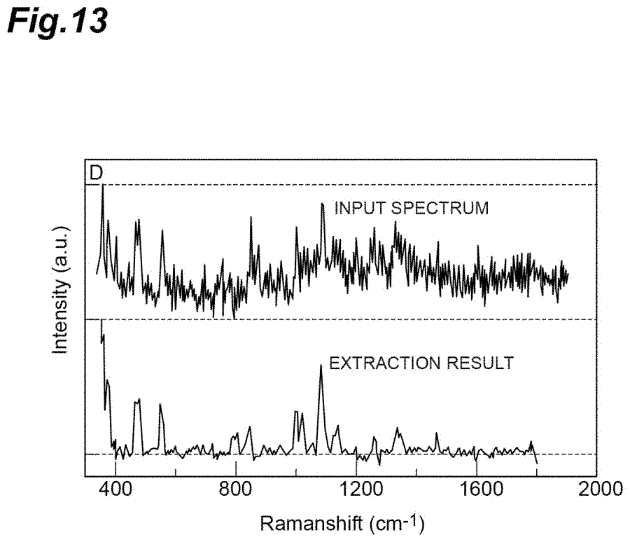

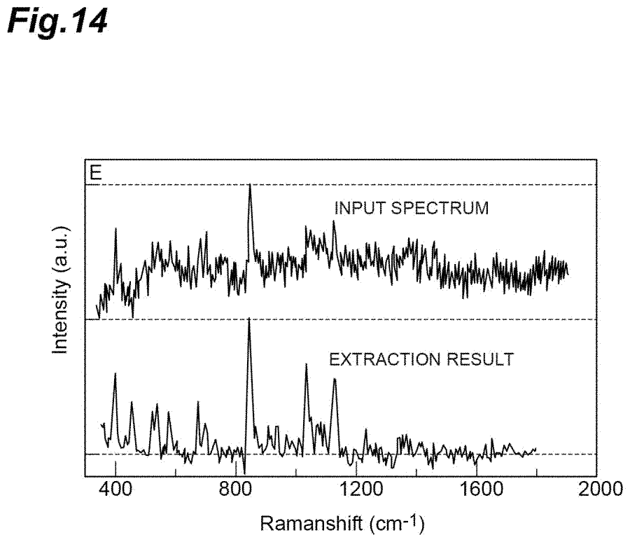

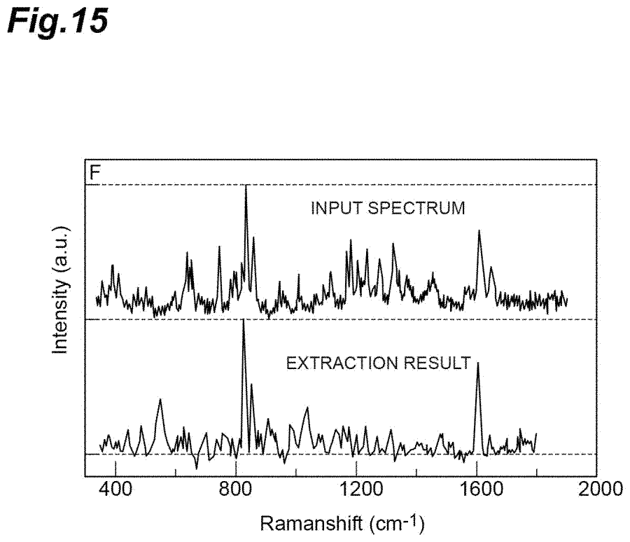

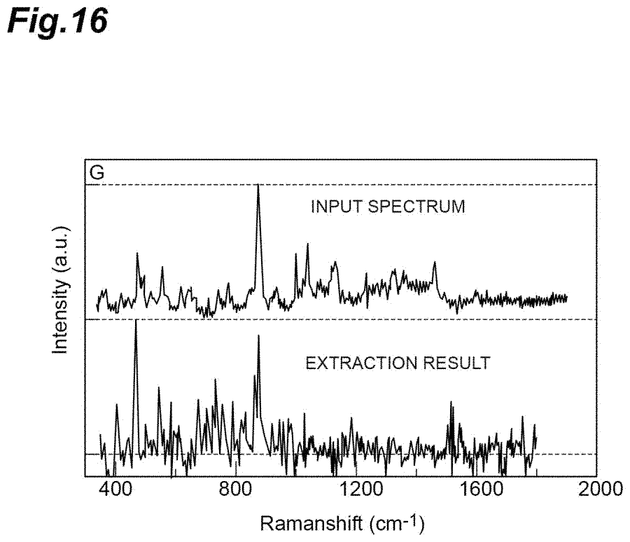

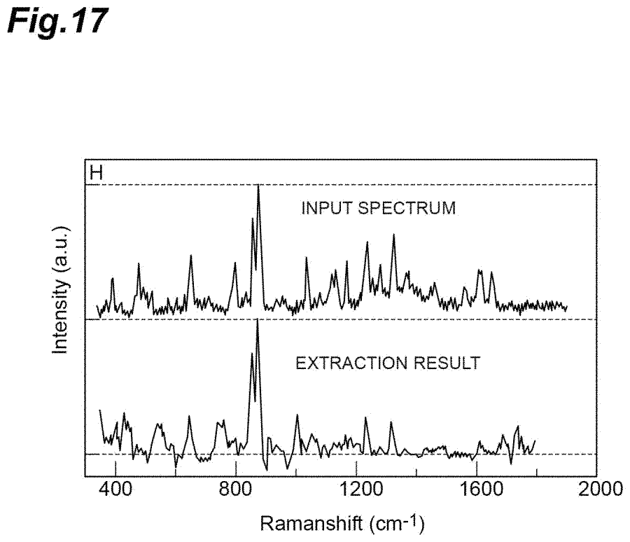

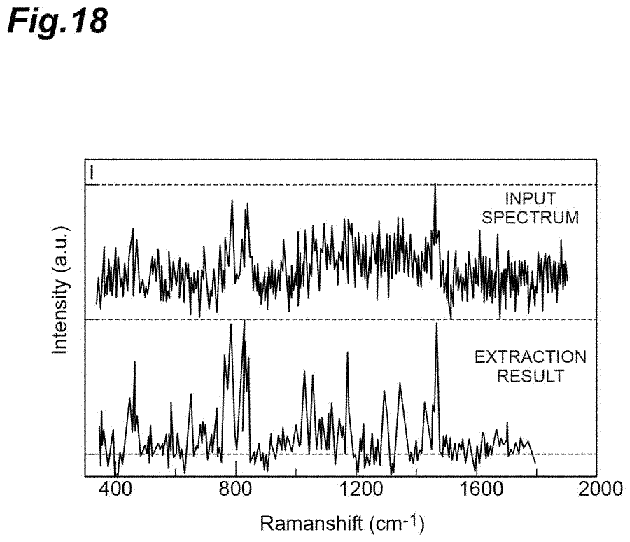

FIG. 10 shows an example for the drug A. FIG. 11 shows an example for the drug B. FIG. 12 shows an example for the drug C. FIG. 13 shows an example for the drug D. FIG. 14 shows an example for the drug E. FIG. 15 shows an example for the drug F. FIG. 16 shows an example for the drug G FIG. 17 shows an example for the drug H. FIG. 18 shows an example for the drug I.

For each of the drugs, it is shown that the discriminative region serving as the classification basis exists at a position of a strong peak in the evaluation spectrum. On the other hand, the value of Q_{c,i} is small at a position of a relatively weak peak in the evaluation spectrum or at a position where a background intensity of the evaluation spectrum is observed. In the case of the drug D (FIG. 13), Q_{c,i} has a large value around the wavenumber of 360 cm⁻¹ at which the drug D can be separated from the other eight drugs. From these facts, it can be confirmed that, according to the present embodiment, it is possible to extract the discriminative region serving as the classification basis by the CNN.

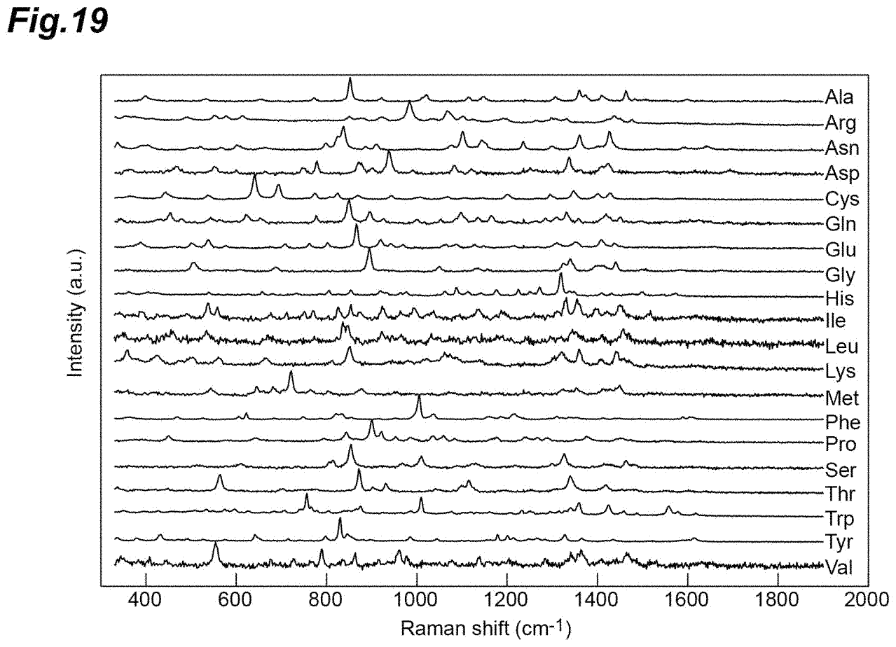

The fourth example is as follows. In the fourth example, as the training spectra and the evaluation spectra, those prepared from Raman spectra of the following twenty amino acids were used. FIG. 19 is a diagram showing examples of spectra of the twenty amino acids used in the fourth example.
Alanine (Ala), Arginine (Arg), Asparagine (Asn), Aspartic Acid (Asp), Cysteine (Cys), Glutamine (Gln), Glutamic Acid (Glu), Glycine (Gly), Histidine (His), Isoleucine (Ile), Leucine (Leu), Lysine (Lys), Methionine (Met), Phenylalanine (Phe), Proline (Pro), Serine (Ser), Threonine (Thr), Tryptophan (Trp), Tyrosine (Tyr), Valine (Val)

A Raman spectrum measured for each amino acid was subjected to interpolation processing to generate a spectrum in a wavenumber range of 350 cm⁻¹ to 1800 cm⁻¹ at intervals of 1 cm⁻¹. These spectra were combined using any one amino acid in the twenty amino acids as a host, and any other amino acid as a guest. Five spectra were generated for each host, and normalized with the maximum peak value as 1. In total, 1900 (=20×19×5) spectra were generated.

For the training spectrum, the mixing ratio of the spectrum of the host amino acid and the spectrum of the guest amino acid was set to be random in the range of 1:0.1 to 1:0.5. The training labels were given as a one-hot vector of the host amino acid. For the evaluation spectrum, the mixing ratio of the spectrum of the host amino acid and the spectrum of the guest amino acid was set to 1:0.45.

In the fourth example, the configuration same as that of the CNN used in the third example was used. The training spectrum and the training labels were used to train the CNN. An evaluation spectrum different from the training spectrum was input to the CNN, and the classification of the evaluation spectrum was performed by the CNN. A discriminative region being a classification basis was obtained from the fully connected layer.

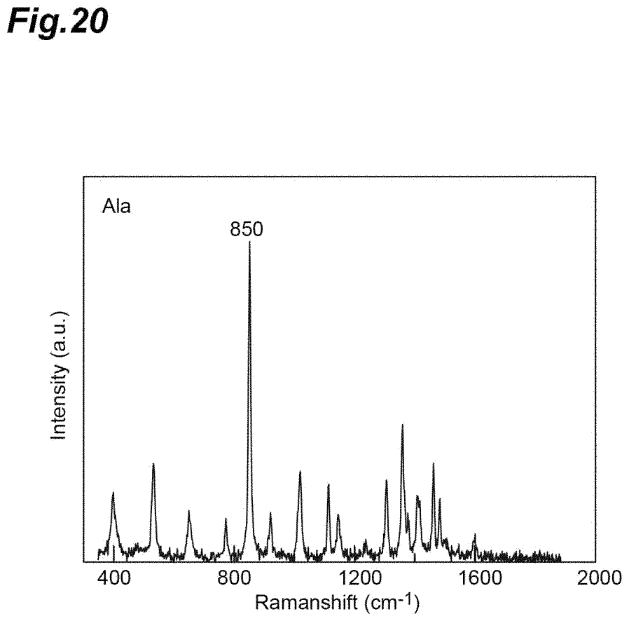

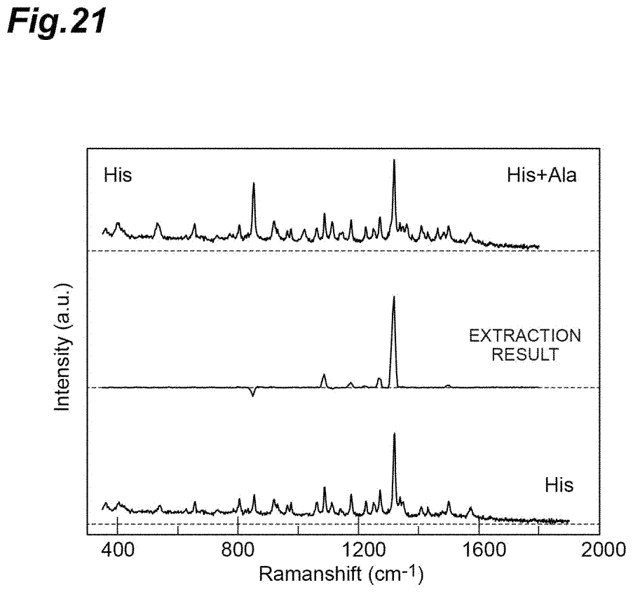

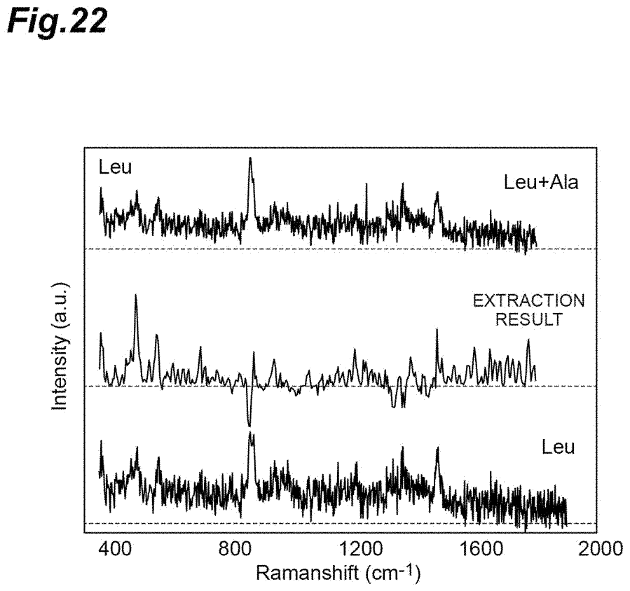

FIG. 20 is a diagram showing a pure spectrum of alanine (Ala) used in the fourth example. Each of FIG. 21 and FIG. 22 is a diagram showing a discriminative region serving as a classification basis obtained in the fourth example.

FIG. 21 shows an evaluation spectrum in which the host is histidine (His) and the guest is alanine (Ala), a data string Q_{c} (Formula (3)) showing the discriminative region serving as the classification basis obtained when the spectrum is input to the CNN, and a pure spectrum of histidine (His). It is shown that the discriminative region serving as the classification basis exists at a position of a strong peak of the spectrum of histidine (His) as the host.

On the other hand, Q_{c,i} is a negative value at a position of a strong peak of the pure spectrum of alanine (Ala) as the guest (near the wavenumber of 850 cm⁻¹). That is, it can be understood that the CNN learns that the peak near the wavenumber of 850 cm⁻¹ shown in the evaluation spectrum is a region that is not necessary for the classification of histidine (His).

FIG. 22 shows an evaluation spectrum in which the host is leucine (Leu) and the guest is alanine (Ala), a data string Q_{c} (Formula (3)) showing the discriminative region serving as the classification basis obtained when the spectrum is input to the CNN, and a pure spectrum of leucine (Leu). The SN ratio of the pure spectrum of leucine (Leu) is poor, but even in such a case, it is also shown that the discriminative region serving as the classification basis exists at a position of a strong peak of the spectrum of leucine (Leu) as the host.

The position of the strong peak in the pure spectrum of leucine (Leu) as the host is near the wavenumber of 850 cm⁻¹, which is close to the position of the strong peak in the pure spectrum of alanine (Ala) as the guest, however, this peak position observed in the evaluation spectrum is not considered to contribute to the classification of leucine (Leu). It is considered that other peaks at wavenumbers of around 475 cm⁻¹ and around 545 cm⁻¹ in the evaluation spectrum contribute to the classification of leucine (Leu).

Good results were similarly obtained for other host and guest combinations. From these facts, it can be confirmed that, according to the present embodiment, it is possible to extract the discriminative region serving as the classification basis by the CNN.

The CNN decision basis extraction apparatus and the CNN decision basis extraction method of the present embodiment are not limited to the case where the input data is a spectrum, and can be applied to other input data (for example, image data). According to the present embodiment, even when the number of hidden layers of the CNN is small or the size of the filter used in the convolutional layer is small, it is possible to extract the discriminative region serving as the decision basis by the CNN in the input data. Further, the CNN decision basis extraction apparatus and the CNN decision basis extraction method of the present embodiment make it possible to facilitate design and verification of a CNN model and guarantee reliability, and can be expected to provide a CNN model that is easy for the user to understand.

In addition, the CNN decision basis extraction apparatus and the CNN decision basis extraction method of the present embodiment can extract the common portion by training the CNN with the same training labels for the sample containing the same species in the classification of the mixed spectrum, and further, since a negative value is obtained for the portion which is considered to reduce the classification probability (fourth example), it can be used not only for visualization of the common component but also for identification of unnecessary contents in authenticity determination or the like.

In the embodiment and the first to fourth examples described above, the contribution rate of the weight 36 of the fully connected layer to any output label of the output layer 17 is obtained, and the decision basis of the CNN 10 is extracted using the contribution rate. As in an embodiment and fifth and sixth examples described below, it is also possible to obtain the contribution rate of the feature vector 26 to any output label of the output layer 17 and extract the decision basis of the CNN 10 using the contribution rate.

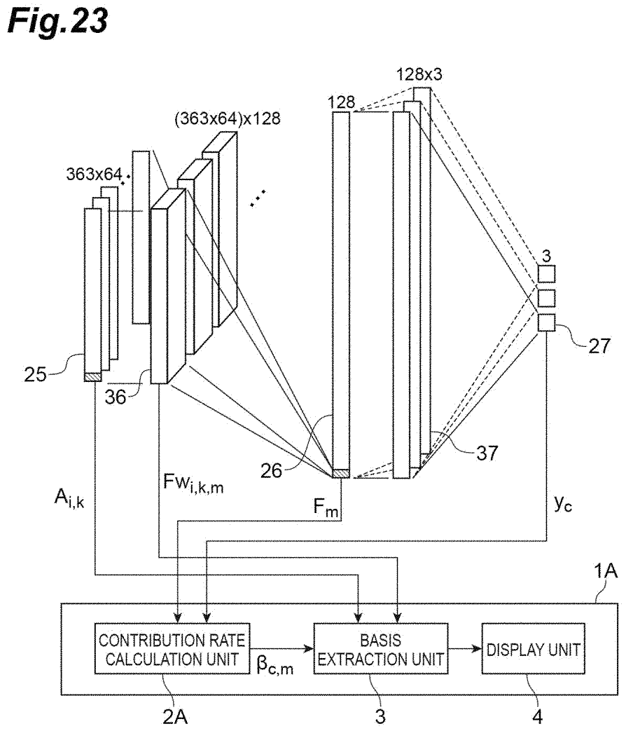

FIG. 23 is a diagram illustrating a configuration of a convolutional neural network decision basis extraction apparatus 1A. In this diagram, in addition to the convolutional neural network decision basis extraction apparatus (CNN decision basis extraction apparatus) 1A, the feature map 25, the feature vector 26, the output label 27 of the output layer, the weight 36 of the fully connected layer, and the weight 37 of the output layer in the CNN 10 are also illustrated.

The CNN decision basis extraction apparatus 1A can also be realized by a computer including a CPU, a memory, and the like, and includes a display unit such as a liquid crystal display that displays input data, output data, and the like. The CNN decision basis extraction apparatus 1A may be realized by a computer together with the CNN 10.

The CNN decision basis extraction apparatus 1A includes a contribution rate calculation unit 2A and a basis extraction unit 3, and preferably further includes a display unit 4. Compared with the configuration illustrated in FIG. 2, the CNN decision basis extraction apparatus 1A illustrated in FIG. 23 is different in that it includes the contribution rate calculation unit 2A instead of the contribution rate calculation unit 2.

The contribution rate calculation unit 2A obtains the contribution rate of the feature vector 26 to any output label of the output layer 17. The feature vector 26 is generated based on the feature map (A_{i,k}) input to the fully connected layer and the weight (Fw_{i,k,m}) of the fully connected layer. The contribution rate β_{c,m} of the m-th component Fₘ of the feature vector 26 to the value y_{c} of the label c in the output labels 27 is represented by the following Formula (4), as a ratio of the change amount of y_{c} to the change amount of Fₘ.

$$\begin{matrix}[ Formula 4 ] & \\ {β}_{c , m} = \frac{\partial {y}_{c}}{\partial {F}_{m}} & ( 4 )\end{matrix}$$

The basis extraction unit 3 extracts the basis of the decision in the CNN 10 based on the feature map 25 input to the fully connected layer 16, the weight 36 of the fully connected layer, and the above contribution rate β_{c,m}. An i-th value Q_{c,i} of a data string Q_{c} showing the decision basis of the CNN 10 is represented by the above Formula (3), as a value obtained by summing the products of A_{i,k}, β_{c,m} and Fw_{i,k,m} for k and in.

The convolutional neural network decision basis extraction method (CNN decision basis extraction method) includes a contribution rate calculation step and a basis extraction step, and preferably further includes a display step. In the contribution rate calculation step, the contribution rate β_{c,m} of the feature vector 26 to the output label of the output layer 17 is obtained (Formula (4)). In the basis extraction step, the decision basis of the CNN 10 is extracted based on the feature map 25 input to the fully connected layer 16, the weight 36 of the fully connected layer, and the contribution rate β_{c,m} (Formula (3)). In the display step, the data string Q_{c} representing the decision basis of the CNN 10 is displayed in association with the input data input to the input layer 11.

Next, a fifth example and a sixth example will be described. The fifth example was different from the third example only in the contribution rate calculation, and the other conditions were the same. Further, the sixth example was different from the fourth example only in the contribution rate calculation, and the other conditions were the same. In addition, when alanine (Ala) was used as the host, arginine (Arg) was used as the guest, and when an amino acid other than alanine (Ala) was used as the host, alanine (Ala) was used as the guest.

In the third example and the fourth example, the contribution rate (Formula (2)) of the weight 36 of the fully connected layer to the output label of the output layer 17 was obtained, whereas in the fifth example and the sixth example, the contribution rate (Formula (4)) of the feature vector 26 to the output label of the output layer 17 was obtained.

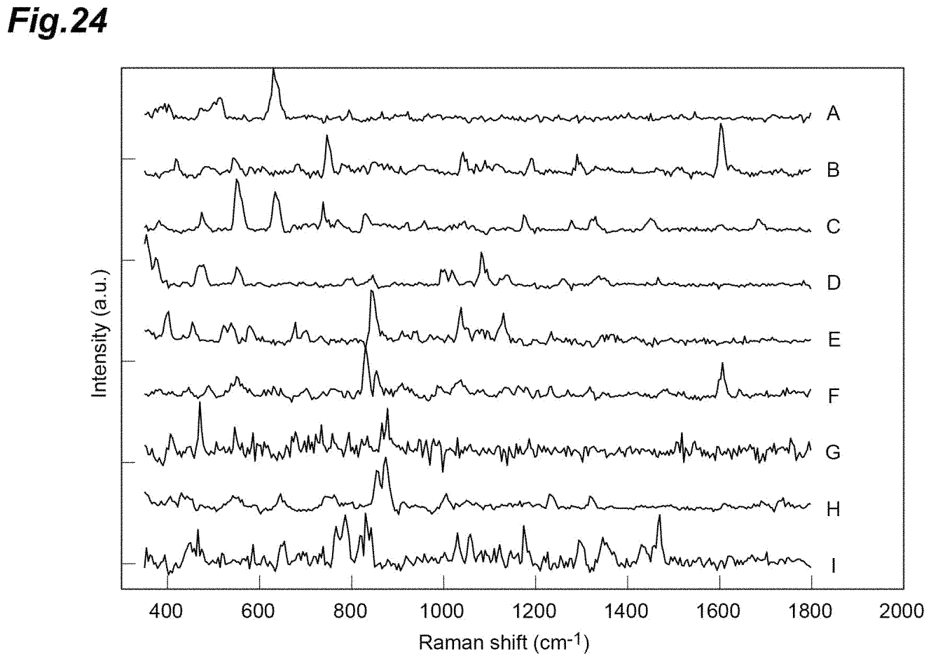

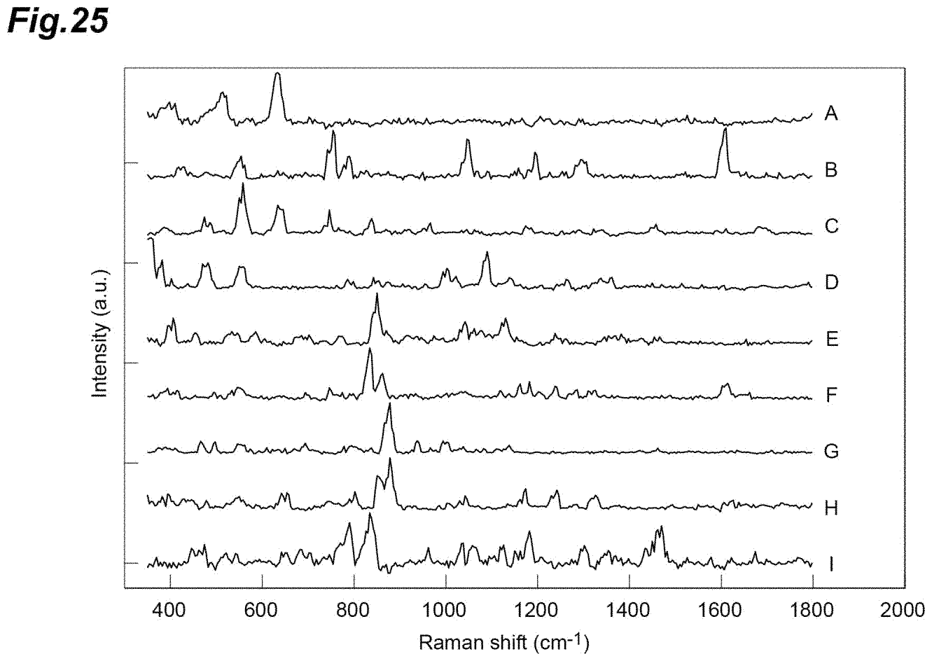

FIG. 24 is a diagram showing the discriminative region serving as the classification basis obtained in the third example. FIG. 25 is a diagram showing the discriminative region serving as the classification basis obtained in the fifth example. The third example (FIG. 24) and the fifth example (FIG. 25) differ only in the contribution rate calculation, and similar discriminative regions were extracted as the classification basis by the CNN.

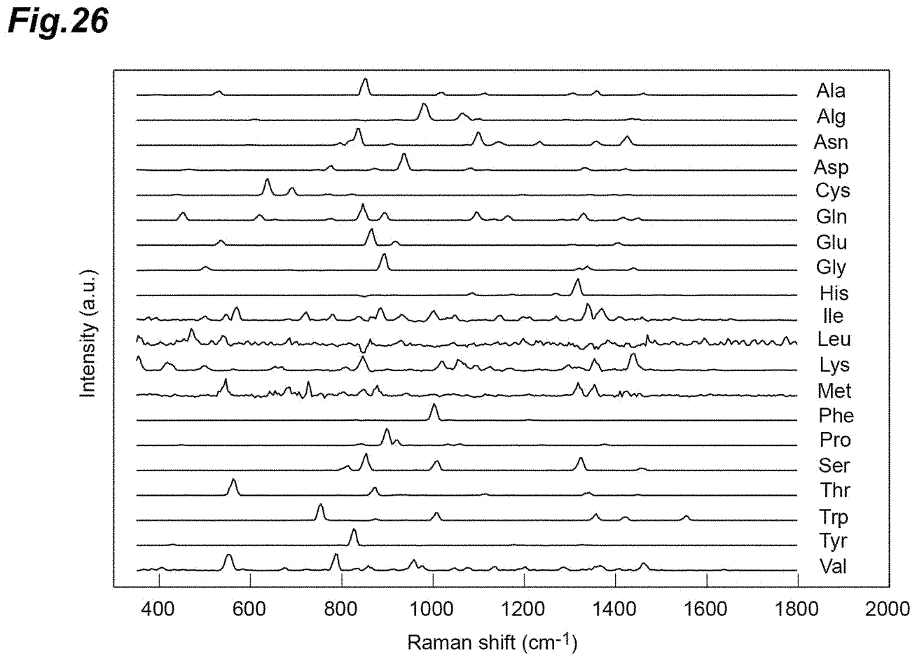

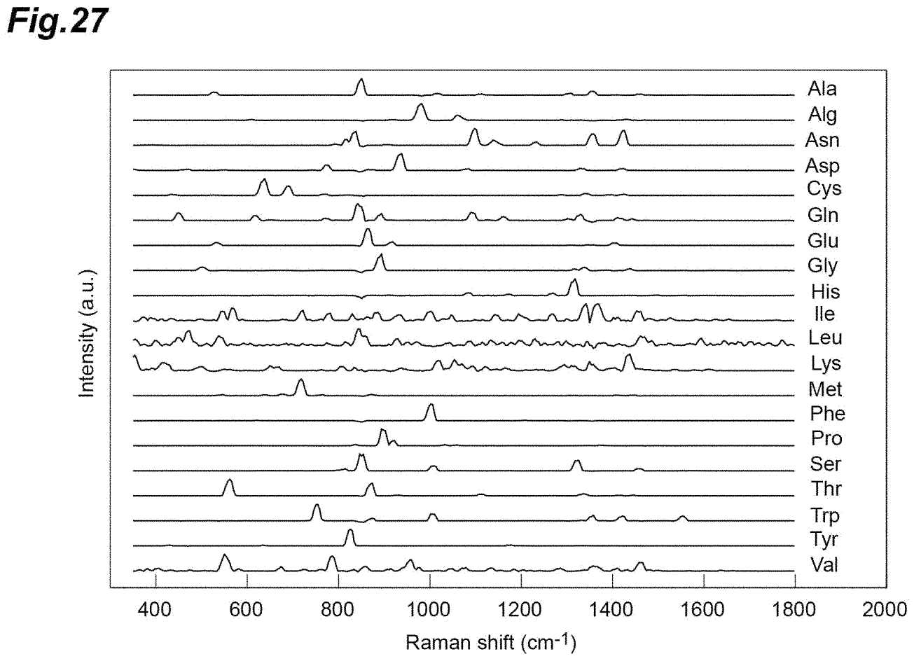

FIG. 26 is a diagram showing the discriminative region serving as the classification basis obtained in the fourth example. FIG. 27 is a diagram showing the discriminative region serving as the classification basis obtained in the sixth example. The fourth example (FIG. 26) and the sixth example (FIG. 27) differ only in the contribution rate calculation, and similar discriminative regions were extracted as the classification basis by the CNN.

Further, when the contribution rate (Formula (4)) of the feature vector 26 was used instead of the contribution rate (Formula (2)) of the weight 36 of the fully connected layer in each of the first example and the second example, the similar discriminative region was extracted as the classification basis by the CNN.

As described above, similarly to the case of using the contribution rate (Formula (2)) of the weight 36 of the fully connected layer to the output label of the output layer 17, also in the case of using the contribution rate (Formula (4)) of the feature vector 26 to the output label of the output layer 17, the discriminative region serving as the decision basis by the CNN in the input data can be extracted, even when the number of hidden layers of the CNN is small or the size of the filter used in the convolutional layer is small.

The convolutional neural network decision basis extraction method and apparatus of the present invention are not limited to the above embodiments and configuration examples, and various modifications are possible.

The convolutional neural network decision basis extraction method of the above embodiment is a method for extracting a decision basis of a convolutional neural network having an input layer, a convolutional layer, a pooling layer, a fully connected layer, and an output layer, and includes a contribution rate calculation step of obtaining a contribution rate of a weight of the fully connected layer to an output label of the output layer; and a basis extraction step of extracting the basis based on a feature map input to the fully connected layer, the weight of the fully connected layer, and the contribution rate.

In the convolutional neural network decision basis extraction method of the above configuration, in the contribution rate calculation step, instead of the contribution rate of the weight of the fully connected layer, a contribution rate of a feature vector generated by the fully connected layer may be obtained. The feature vector is generated based on the feature map input to the fully connected layer and the weight of the fully connected layer.

The convolutional neural network decision basis extraction method of the above configuration may further include a display step of displaying the basis in association with input data input to the input layer.

The convolutional neural network decision basis extraction apparatus of the above embodiment is an apparatus for extracting a decision basis of a convolutional neural network having an input layer, a convolutional layer, a pooling layer, a fully connected layer, and an output layer, and includes a contribution rate calculation unit for obtaining a contribution rate of a weight of the fully connected layer to an output label of the output layer; and a basis extraction unit for extracting the basis based on a feature map input to the fully connected layer, the weight of the fully connected layer, and the contribution rate.

In the convolutional neural network decision basis extraction apparatus of the above configuration, the contribution rate calculation unit may obtain, instead of the contribution rate of the weight of the fully connected layer, a contribution rate of a feature vector generated by the fully connected layer.

The convolutional neural network decision basis extraction apparatus of the above configuration may further include a display unit for displaying the basis in association with input data input to the input layer.

### INDUSTRIAL APPLICABILITY

The present invention can be used as a method and an apparatus capable of extracting a discriminative region serving as a decision basis by a CNN in input data, even when the number of hidden layers of the CNN is small or a size of a filter used in a convolutional layer is small.

### REFERENCE SIGNS LIST

1, 1A—convolutional neural network decision basis extraction apparatus (CNN decision basis extraction apparatus), 2, 2A—contribution rate calculation unit, 3—basis extraction unit, 4—display unit, 10, 10A—convolutional neural network (CNN), 11—input layer, 12—convolutional layer, 13—pooling layer, 14—convolutional layer, 15—pooling layer, 16—fully connected layer, 17—output layer, 21—input data string, 22-25—feature map, 26—feature vector, 27—output label of output layer, 32, 34—filter, 36—weight of fully connected layer, 37—weight of output layer.

1. A convolutional neural network decision basis extraction method for extracting a decision basis of a convolutional neural network having an input layer, a convolutional layer, a pooling layer, a fully connected layer, and an output layer, the method comprising:
performing a contribution rate calculation of obtaining a contribution rate of a weight of the fully connected layer to an output label of the output layer; and
performing a basis extraction of extracting the basis based on a feature map input to the fully connected layer, the weight of the fully connected layer, and the contribution rate.

2. A convolutional neural network decision basis extraction method for extracting a decision basis of a convolutional neural network having an input layer, a convolutional layer, a pooling layer, a fully connected layer, and an output layer, the method comprising:
performing a contribution rate calculation of obtaining a contribution rate of a feature vector generated by the fully connected layer to an output label of the output layer; and
performing a basis extraction of extracting the basis based on a feature map input to the fully connected layer, a weight of the fully connected layer, and the contribution rate.

3. The convolutional neural network decision basis extraction method according to claim 1, further comprising performing a display of displaying the basis in association with input data input to the input layer.

4. A convolutional neural network decision basis extraction apparatus for extracting a decision basis of a convolutional neural network having an input layer, a convolutional layer, a pooling layer, a fully connected layer, and an output layer, the apparatus comprising:
a contribution rate calculation unit configured to obtain a contribution rate of a weight of the fully connected layer to an output label of the output layer; and
a basis extraction unit configured to extract the basis based on a feature map input to the fully connected layer, the weight of the fully connected layer, and the contribution rate.

5. A convolutional neural network decision basis extraction apparatus for extracting a decision basis of a convolutional neural network having an input layer, a convolutional layer, a pooling layer, a fully connected layer, and an output layer, the apparatus comprising:
a contribution rate calculation unit configured to obtain a contribution rate of a feature vector generated by the fully connected layer to an output label of the output layer; and
a basis extraction unit configured to extract the basis based on a feature map input to the fully connected layer, a weight of the fully connected layer, and the contribution rate.

6. The convolutional neural network decision basis extraction apparatus according to claim 4, further comprising a display unit configured to display the basis in association with input data input to the input layer.

7. The convolutional neural network decision basis extraction method according to claim 2, further comprising performing a display of displaying the basis in association with input data input to the input layer.

8. The convolutional neural network decision basis extraction apparatus according to claim 5, further comprising a display unit configured to display the basis in association with input data input to the input layer.
